(19) United States
(12) Patent Application Publication
(10) Pub. No.: US 2015/0224792 A1
(43) Pub. Date: Aug. 13, 2015

(54) DEVICE FOR PRINTING INFORMATION ON A LABEL

(71) Applicant: David Lutz, Gonzales, TX (US)

(72) Inventor: David Lutz, Gonzales, TX (US)

(21) Appl. No.: 14/178,491

(22) Filed: Feb. 12, 2014

(51) Int. Cl. B41J 3/407

(52) U.S. Cl. CPC B41J 3/4075

(57) ABSTRACT

A device can include a button which when pressed outputs a label that indicates the current date and time, an expiration date, and an identifier of an individual. The label can then be placed on a multidose container so that the multidose container is labeled in accordance with applicable regulations. Accordingly, the required record for labeling a multidose container can be created with a simple press of a button thereby increasing the likelihood that a clinician will adequately label multidose containers. The device can also be used to create labels for other types of containers when a button is pressed.

### CROSS-REFERENCE TO RELATED APPLICATIONS

Not Applicable.

### BACKGROUND

In the health care industry, medicaments are oftentimes provided in sealed containers (e.g. vials) in multidose quantities. When these containers are first opened or the contents otherwise accessed, regulations require that a record be created indicating when the container was opened. This record should typically indicate the date when the container was opened, an expiration date based on the opened date, and the individual who opened the container. For most medicaments, the expiration date is 28 days after the date the container was opened. To comply with these regulations, it is common for the clinician or other administering personnel to write the required opened and expiration dates directly on the vial.

In many cases, medicaments contained in multidose containers are administered in emergency situations or at other times when a record cannot be immediately created. For example, when a patient is brought into the emergency room and requires an immediate infusion of multiple drugs, the clinician will not stop after administering a drug to write the opening and expiration dates on the drug's multidose container. In such situations, the clinicians will typically wait until a later time to go back and create the required records on any multidose containers that were opened.

Various problems arise in these situations. First, if a clinician is busy, he may not have an opportunity to create the required records until after a significant number of multidose containers have been opened. Second, even if the clinician has adequate time, he may forget to go back and create records. In either case, if a multidose container is not adequately labeled, it may be necessary to discard the remaining doses (e.g. if it cannot be determined when the container was opened), and/or the clinician or health care facility may be subject to fines.

### BRIEF SUMMARY

The present invention extends to a device for printing information on a label. The device can include a button which when pressed outputs a label that indicates the current date and time, an expiration date, and an identifier of an individual. The label can then be placed on a multidose container so that the multidose container is labeled in accordance with applicable regulations. Accordingly, the required record for labeling a multidose container can be created with a simple press of a button thereby increasing the likelihood that a clinician will adequately label multidose containers.

In one embodiment, the present invention is implemented as a device for printing information on a label. The device comprises a housing containing a printer, logic circuitry, and a button. The logic circuitry is configured to detect when the button is pressed and cause the printer to output a label having printed thereon the current date and time, an expiration date, and an identifier of an individual.

In another embodiment, the present invention is implemented as a method for printing information on a label. A button press is detected by logic circuitry contained within a housing in which the button is contained. In response to the detection of the button press, the logic circuitry identifies the current date and time and calculates an expiration date based on the identified current date and time. The logic circuitry then causes a printer contained within the housing to output a label containing the current date and time, the expiration date, and an identifier of a user.

In another embodiment, the present invention is implemented as device for creating a label containing regulatory information to be placed on a container containing multiple doses of a medicament. The device comprises a housing containing a printer, logic circuitry, and a button. The logic circuitry is configured to detect when the button is pressed and in response to the detection of the button press: identify the current date and time; calculate an expiration date of a medicament in a multidose container based on the current date; and cause the printer to output a label having printed thereon the current date and time and the expiration date so that the label can be affixed to the multidose container to identify when the multidose container was first opened or accessed and when the medicament in the multidose container will expire.

This summary is provided to introduce a selection of concepts in a simplified form that are further described below in the Detailed Description. This Summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example of a device for printing information on a label;

FIG. 2 illustrates the device of FIG. 1 after a label has been output in response to the press of the button;

FIG. 3 illustrates the label of FIG. 2 after it has been placed on a multidose vial;

FIG. 4 illustrates another example of a device as shown in FIG. 1 with the addition of buttons for controlling a mode of operation of the device;

FIG. 5 illustrates the device of FIG. 4 with the display of various users which may be selected; and

FIG. 6 illustrates the device of FIG. 1 when a single display is used to receive the user's selection of a button.

### DETAILED DESCRIPTION

The present invention extends to a device for printing information on a label. The device can include a button which when pressed outputs a label that indicates the current date and time, an expiration date, and an identifier of an individual. The label can then be placed on a multidose container so that the multidose container is labeled in accordance with applicable regulations. Accordingly, the required record for labeling a multidose container can be created with a simple press of a button thereby increasing the likelihood that a clinician will adequately label multidose containers.

In one embodiment, the present invention is implemented as a device for printing information on a label. The device comprises a housing containing a printer, logic circuitry, and a button. The logic circuitry is configured to detect when the button is pressed and cause the printer to output a label having printed thereon the current date and time, an expiration date, and an identifier of an individual.

In another embodiment, the present invention is implemented as a method for printing information on a label. A button press is detected by logic circuitry contained within a housing in which the button is contained. In response to the detection of the button press, the logic circuitry identifies the current date and time and calculates an expiration date based on the identified current date and time. The logic circuitry then causes a printer contained within the housing to output a label containing the current date and time, the expiration date, and an identifier of a user.

In another embodiment, the present invention is implemented as device for creating a label containing regulatory information to be placed on a container containing multiple doses of a medicament. The device comprises a housing containing a printer, logic circuitry, and a button. The logic circuitry is configured to detect when the button is pressed and in response to the detection of the button press: identify the current date and time; calculate an expiration date of a medicament in a multidose container based on the current date; and cause the printer to output a label having printed thereon the current date and time and the expiration date so that the label can be affixed to the multidose container to identify when the multidose container was first opened or accessed and when the medicament in the multidose container will expire.

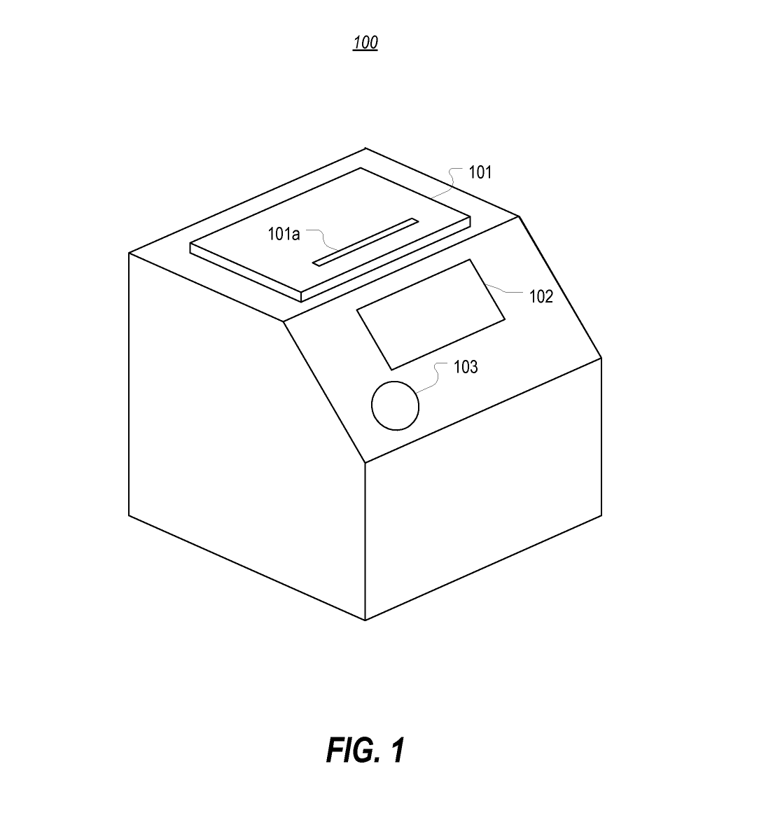

FIG. 1 illustrates an example of a device 100 for printing information on a label in accordance with one or more embodiments of the invention. Device 100 comprises a housing containing a printer 101, a display 102, and a button 103. Preferably, device 100 has a relatively small size to allow the device to be placed in many different locations. For example, when device 100 is used within an emergency, operating, or other room in which health care is provided, the device can be small enough to be conveniently placed on a cart such as an anesthesia cart.

As described in the background, various health care regulations dictate that when a multidose container is opened or otherwise accessed, the container should be labeled with the date and time when it was opened, an expiration date based on the date and time when opened, and an identifier of the user that opened the container. Device 100 facilitates the labeling of a container with this information.

Device 100 includes logic circuitry for causing printer 101 to output a label (or sticker) containing such information when button 103 is pressed. In this way, a clinician can quickly and easily label a multidose container with the necessary information by simply pressing button 103. In response to the press of button 103, the logic circuitry within device 100 identifies the current date and time and calculates an expiration date (e.g. 28 days from the current date) and then causes printer 101 to output a label containing this information and a user identifier.

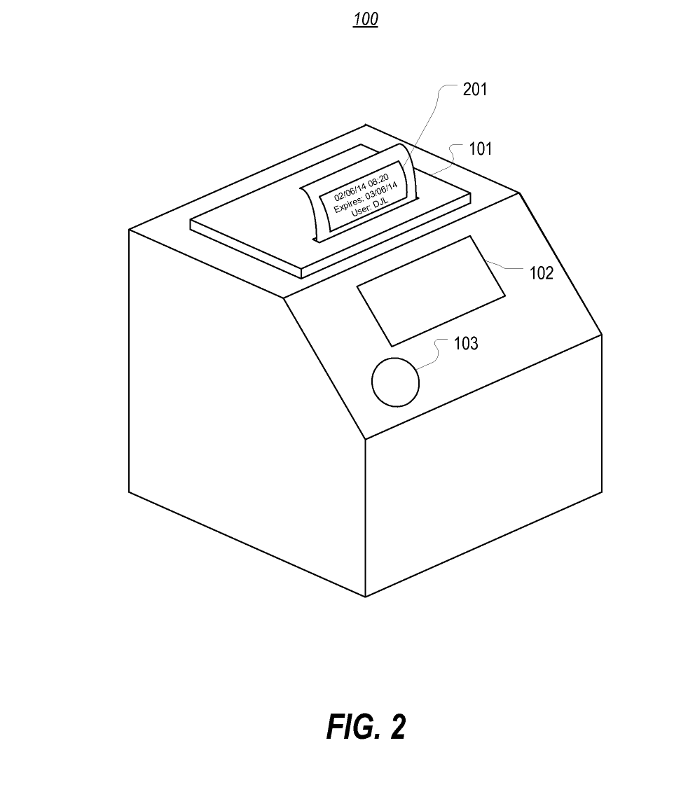

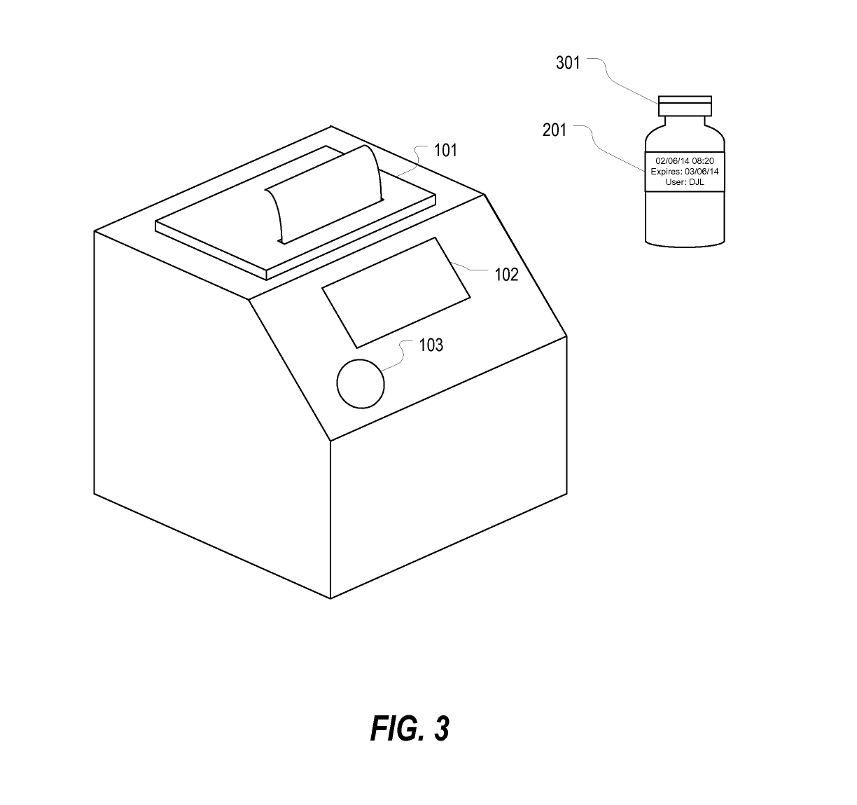

FIGS. 2 and 3 illustrate an example of how device 100 can output a label 201 containing information for labelling a multidose container. As shown in FIG. 2, label 201 lists a current date and time of 02/06/14 08:20, an expiration date of 03/06/14 (28 days from 02/06/14), and a user identifier of DJL. Label 201 can be output in response to the clinician pressing button 103. Once label 201 is output, the clinician can quickly remove the label from the feed paper and apply it to the multidose container as shown in FIG. 3. Because the process of creating label 201 only requires that the clinician press a single button, the clinician is more likely to label the multidose container soon after opening it.

In many situations, each clinician in a facility will maintain his own medicaments. For example, an anesthesiologist typically maintains his own anesthesia cart within which various multidose containers are stored. In such situations, each clinician can obtain his own device 100 so that the user identifier does not need to be updated. Similarly, most multidose containers have an expiration date that is 28 days after they are opened, and therefore, the logic for calculating the expiration date does not typically need to be changed. However, in situations where multiple users may share a single device 100 or different expiration date calculations need to be used, device 100 may include additional components for allowing the user to select a desired user or expiration date calculation.

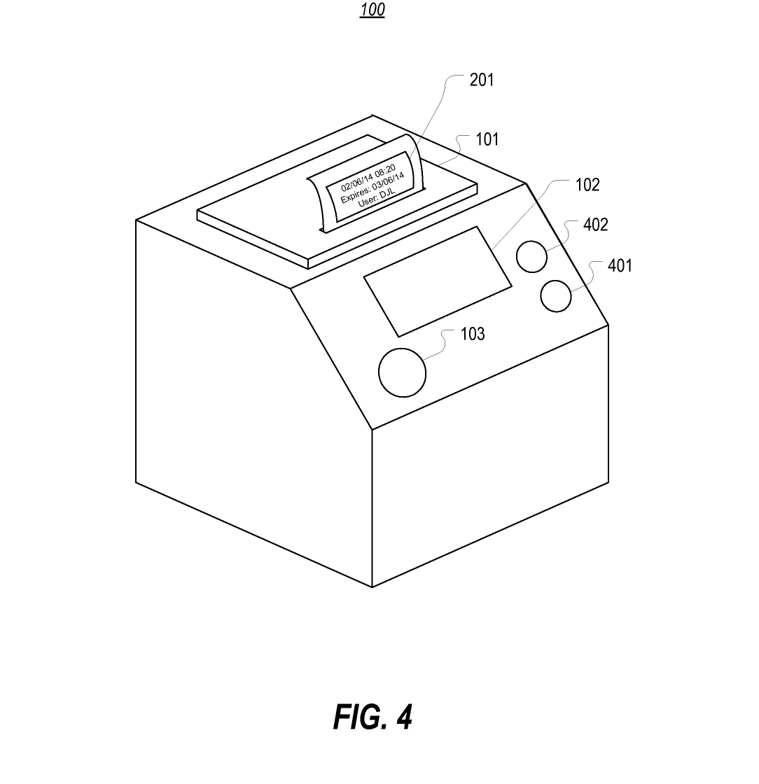

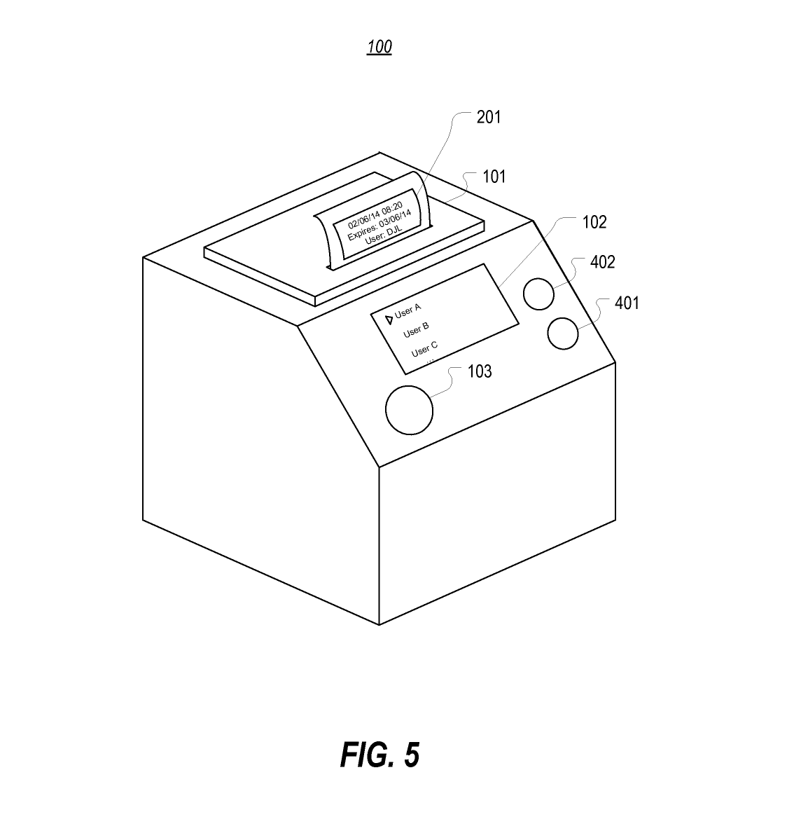

FIGS. 4 and 5 illustrate an example of device 100 that includes buttons 401 and 402. Buttons 401 and 402 can be used to provide input to the logic circuitry of device 100. For example, in some embodiments, button 402 can comprise a mode button that causes display 102 to cycle through the various configurable parameters of device 100. These configurable parameters may include the selection or input of a user identifier to be used when printing labels and/or the selection or input of an expiration date calculation to employ when calculating the expiration date to be printed when button 103 is pressed. Button 401 can be configured to allow the user to cycle through available options (e.g. a list of user identifiers programmed into the device).

FIG. 5, for example, illustrates an example where display 102 lists various user identifiers from which a user can select. This list of user identifiers can be displayed, for example, in response to the user pressing button 402 one or more times. In a particular implementation, the user can press button 401 to cycle through the listed user identifiers until a desired user identifier is selected. Once a user identifier is selected, the logic circuitry can cause printer 101 to output the selected user identifier each time button 103 is pressed. A similar process can be provided to allow the user to select from among various expiration date calculations (e.g. 28 days, 35 days, 42 days, etc.).

Although device 100 depicted in the figures employs a physical button 103 and a display 102, the same functionality can be provided using only a touch screen interface. In other words, a device for printing information on a label could include a single display that can display a selectable button which when selected causes the output of a label as described above. Accordingly, the present invention should not be limited to any particular arrangement of physical components, but should encompass the functionality provided by any arrangement of components that allows a label to be printed in response to a single input from the user.

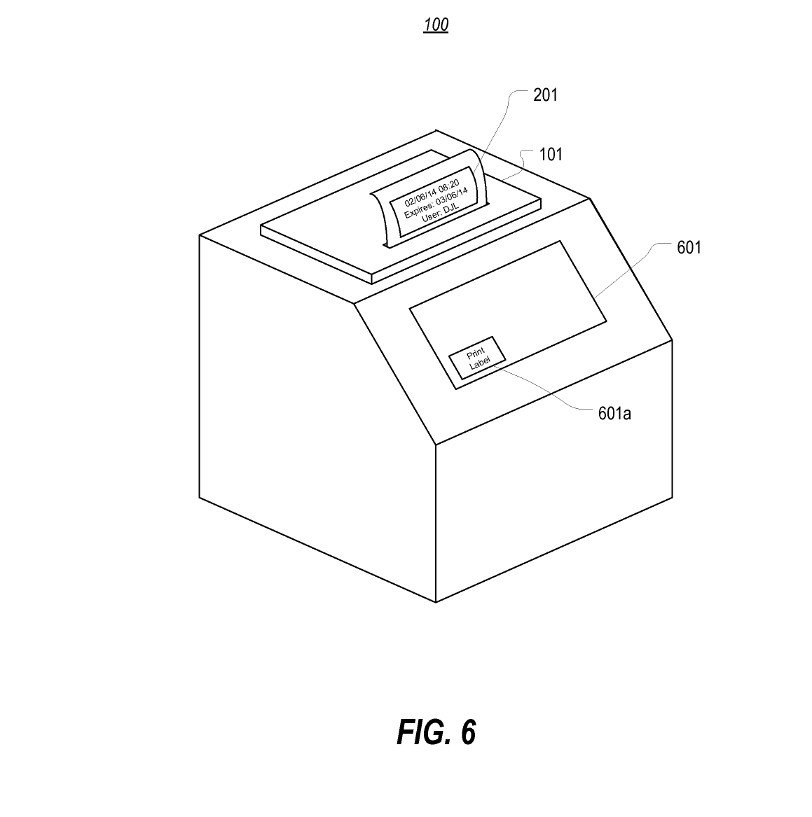

FIG. 6 provides an example of how device 100 can be configured with a single display 601 on which a user interface button 601 a is provided. The logic circuitry within device 100 can be configured to respond to a press of button 601 a in the same manner as described above when button 103 is pressed. Specifically, when button 601a is pressed, label 201 can be output that lists the current date and time, the expiration date, and a user identifier.

Although not depicted in the figures, the display (e.g. display 102 or display 601) can be configured to display the same information that is printed on a label. For example, when button 103 or 601 a is pressed, display 102 or 601 respectively can display the current date and time, the expiration date, and the user identifier that is or will be printed on label 201. In this way, the clinician can verify, by reading the information displayed on the display, that the information printed (or to be printed) on label 201 is correct.

The above description has been directed to the use of device 100 in the health care industry to label multidose containers. However, device 100 could also be used in other industries where the labeling of a container is required or desired. For example, in the food services industry, some regulations require that a container of food be labeled when the container is opened. The information required can include the date and time when the container was opened, an expiration date, and possibly the user that opened the container. Device 100 can be used to output a label containing the necessary information in such scenarios.

Accordingly, embodiments of the present invention are directed to facilitating the creation of a label containing required information for a multidose container. A user can quickly create a label for a multidose container by simply pressing a button or otherwise providing input to a device which then outputs a label containing the necessary information. The device can be configured to generate the appropriate information any time the button is pressed without requiring any other input from the user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A device for printing information on a label, the device comprising:
a housing containing a printer, logic circuitry, and a button; wherein the logic circuitry is configured to detect when the button is pressed and cause the printer to output a label having printed thereon the current date and time, an expiration date, and an identifier of an individual.

2. The device of claim 1, wherein the expiration date is calculated from the current date and time.

3. The device of claim 1, wherein the housing further comprises a display.

4. The device of claim 3, wherein the logic circuitry causes the display to also display the current date and time, the expiration date, and the identifier of an individual when the button is pressed.

5. The device of claim 1, wherein the identifier of an individual is an identifier of a clinician that opened a multidose container on which the label is to be affixed.

6. The device of claim 5, wherein the expiration date defines the expiration date of a medicament in the multidose container.

7. The device of claim 5, wherein the current date and time represents when the multidose container was first opened or accessed.

8. The device of claim 1, wherein the housing includes one or more other buttons for modifying which identifier of an individual is output on a label when the button is pressed.

9. The device of claim 1, wherein the housing includes a display and the button is a user interface element displayed on the display.

10. The device of claim 1, wherein the expiration date is 28 days after the current date.

11. The device of claim 1, wherein the label is a sticker.

12. A method for printing information on a label, the method comprising:
detecting, by logic circuitry contained within a housing, an actuation of a button provided on the housing;
in response to the detection of the button actuation, identifying the current date and time and calculating an expiration date based on the identified current date and time; and
causing a printer contained within the housing to output a label containing the current date and time, the expiration date, and an identifier of a user.

13. The method of claim 1, wherein the current date and time represents a date and time when a multidose container is first opened or accessed.

14. The method of claim 13, wherein the label is a sticker that contains only the current date and time, the expiration date, and the identifier of the user.

15. The method of claim 13, wherein expiration date represents an expiration date of a medicament contained within the multidose container.

16. The method of claim 12, wherein the button is a user interface element displayed on a display contained within the housing.

17. The method of claim 16, further comprising:
in response to the detection of the button actuation, displaying the current date and time, the expiration date, and the identifier of a user on the display.

18. The method of claim 12, wherein the expiration date is 28 days after the current date.

19. The method of claim 12, wherein the identifier of the user represents a user who opened or accessed a multidose container on which the label is to be affixed.

20. A device for creating a label containing regulatory information to be placed on a container containing multiple doses of a medicament, the device comprising:
a housing containing a printer, logic circuitry, and a button;
wherein the logic circuitry is configured to detect when the button is pressed and in response to the detection of the button press:
(1) identify the current date and time;
(2) calculate an expiration date of a medicament in a multidose container based on the current date; and
(3) cause the printer to output a label having printed thereon the current date and time and the expiration date so that the label can be affixed to the multidose container to identify when the multidose container was first opened or accessed and when the medicament in the multidose container will expire.
